(19) United States
(12) Patent Application Publication
(10) Pub. No.: US 2003/0014164 A1
(43) Pub. Date: Jan. 16, 2003

(54) Apparatus and method for disabling a remote control unit of an automobile

(76) Inventor: Sung Woo Shin, Kyungki-Do (KR)

Correspondence Address: Pennie & Edmonds, LLP, 3300 Hillview Avenue, Palo Alto, CA, 94304, US

(21) Appl. No.: 10/189,921

(22) Filed: Jul. 3, 2002

(30) Foreign Application Priority Data
Jul. 4, 2001 (KR) 2001-39830

(51) Int. Cl. G06F 17/00

(52) U.S. Cl. 701/2; 340/426

(57) ABSTRACT

The present invention relates to an apparatus and a method for disabling a remote control unit of an automobile. The present invention provides an apparatus to disable a remote control unit of an automobile, comprising an inner antenna for detecting the presence of the remote control unit, which is mistakenly left in the automobile, and an antenna controller for activating said inner antenna. In addition, the present invention provides a method to disable a remote control unit of an automobile, comprising steps of detecting the presence of the remote control unit mistakenly left in the automobile, inputting the identification code of the remote control unit left in the automobile when the detected signal is inputted to the CPU, and temporarily suspending processing of control signals generated by the remote control unit left in the automobile.

### FIELD OF THE INVENTION

The present invention relates to an apparatus and a method to disable a remote control unit of an automobile, and more particularly, to an apparatus and a method to enhance a security system and burglarproof device by disabling the remote control unit left in an automobile when a door is locked using another remote control unit.

### BACKGROUND OF THE INVENTION

In general, automobiles are provided with a uniquely configured ignition key for locking/unlocking doors and turning the engine on and off. However, an ignition key alone is not advantageous as a security system in that it cannot prevent an automobile from being relatively easily stolen because ignition keys can be duplicated without much difficulty. Therefore, as a way to overcome the above drawback, there have been numerous efforts made to develop a remote control security system with additional protection.

In such a remote control security system, the remote control unit should be carried by the driver at all times. In case of malfunction or loss of the remote control unit, additional remote control units can be provided. The system can be effective in preventing theft of an automobile because it is difficult to duplicate the remote control unit. However, there can arise another problem using the plurality of remote control units together. Namely, if a driver accidentally leaves a remote control unit in an automobile and locks doors by means of another remote control unit, there will be a danger that the automobile would be under the control of an intruder who finds the remote control unit left therein.

### SUMMARY OF THE INVENTION

In a preferred embodiment the present invention comprises an inner antenna for detecting the presence of a remote control unit which is accidentally left in the automobile, and an controller for activating the inner antenna.

A method to disable a remote control unit of an automobile according to an embodiment of the present invention comprises inputting a locking signal generated from one of the remote control units carried by a driver into a CPU of the ECU, detecting the presence of the remote control unit, which is mistakenly left in the automobile, inputting the identification code of the remote control unit left in the automobile into the CPU, and temporarily suspending processing of the control signal generated by the remote control unit left in the automobile. In addition, a method according to the present invention may further comprise releasing the suspended state of processing the control signal generated by the remote control unit when an unlocking signal from another remote control unit (carried by a driver) is input to the CPU.

In an alternative preferred embodiment, a vehicle security system according to the invention comprises at least two remote control units and a vehicle mounted electronic control unit capable of bi-directional communication with the remote control units. Preferably, the electronic control unit comprises a CPU and two antennas and associate antenna controllers communicating with the CPU. The first antenna is controlled by the first controller for remote bi-directional communication with the remote control units to determine signals such as locking and un-locking signals. The second antenna is controlled by the second controller for detecting and receiving signals from a remote control unit located within the vehicle. The CPU is programmed to disable processing of signals received from a remote control unit that are detected to be within the vehicle by the second antenna. Preferably, the CPU is also programmed to initiate detection of a remote control unit within the vehicle via the second antenna upon receiving a locking signal via the first antenna and to re-enable processing of signals received from the remote control unit within the vehicle upon receipt of an unlocking signal from another remote control unit via the first antenna.

### BRIEF DESCRIPTION OF THE DRAWINGS

The aforementioned aspects and other features of the present invention will be explained in the following description, taken in conjunction with the accompanying drawings, wherein:

FIG. 1 is a block diagram showing the structure of an apparatus for disabling a remote control unit of an automobile according to the present invention; and

FIG. 2 is a flow chart showing the steps for disabling a remote control unit of an automobile according to the present invention.

### DETAILED DESCRIPTION OF PREFERRED EMBODIMENTS

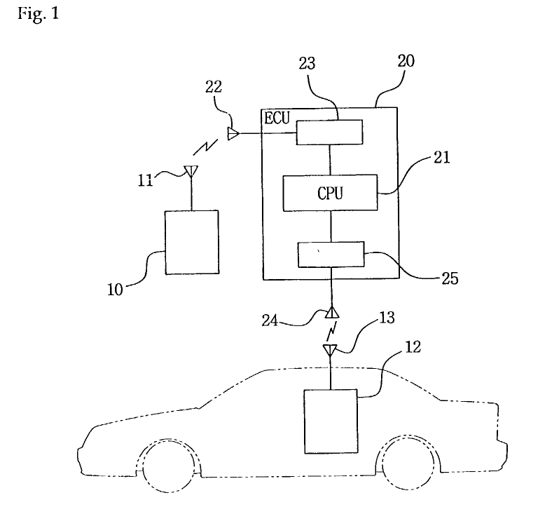

In general the present invention comprises an electronic control unit 20, which communicates with remote control units. In FIG. 1, remote control unit 10 is carried by a driver and remote control unit 12 has been inadvertently left in the car. A driver can control locking/unlocking of doors, ignition of the engine, and activation of other accessories in an automobile such as a heater or an air-conditioner by means of the remote controller. The remote control security system generally comprises a remote control unit for communicating with a device fixed in a vehicle through unique radio signal. The electronic control unit (hereinafter referred to as ECU) determines authenticity of the remote control units by bi-directional communication.

A remote control unit may comprise a memory, a circuit for recording, reading, and amending information onto the memory, and electrically erasable program (hereinafter referred to as EEP) ROM, wherein the remote control unit can generate a unique radio signal within a predetermined range. Furthermore, the remote control unit is provided with a transceiver capable of bi-directional communication with the ECU, whereby the remote control unit is able to send an encoded password signal stored therein to the ECU in response to the request of ECU. A unique identification code for authenticating is assigned to the remote control unit in advance, wherein the unique identification code is encoded and sent to the ECU through a radio signal when the request of ECU is received.

The ECU preferably comprises a transmitting/receiving antenna for bi-directional communication with the remote control unit, a central processing unit 21 (hereinafter referred to as CPU) for processing the signals received from the remote control unit, and a controller which transfers signals received through said antenna to the CPU in an appropriate form. The CPU generates a request signal for an identification code, determines the authentication of the remote control unit based on the signals received from the remote control unit, and generates a control signal in accordance with the result of determination.

The present invention also includes an inner antenna 24 for detecting the presence of the remote control unit 12 left in the automobile and a controller 25 for activating said inner antenna 24. The inner antenna 24 is connected to the CPU 21 of the ECU 20 through the antenna controller 25, wherein the inner antenna 24 detects the presence of the remote control 12 unit left in the automobile and inputs the identification code of the remote control unit into the CPU 21.

In general, the doors of an automobile are automatically locked by the locking signal input to the CPU when a remote control unit of the security system is out of a predetermined range. Furthermore, the doors are automatically unlocked by the unlocking signal input to the CPU when the remote control unit of the security system is within a predetermined range.

In the present invention, controller 25 of inner antenna 24 is activated in response to a locking signal generated when the doors are locked by one of the remote control units. The remote control units provided with the present invention are assigned an identification code unique to each vehicle for obtaining an authorization from the ECU 20. Each remote control unit is given a different identification code, respectively.

The identification codes of the remote control units 10 and 12 are transferred in the form of a radio signal by means of transmitters/receivers 11, 13 equipped in the remote control units 10, 12. A transmitting/receiving antenna 22 and its associated antenna controller 23 are also shown. Each identification code assigned to a given remote control unit is recorded in the memory of the ECU 20.

Furthermore, in order to disable only the remote control unit 12 left inside the vehicle, the CPU 21 recognizes the radio signal, that is an identification code, from the remote control unit 12 via an inner antenna 24 and controller 25. The CPU 21 then suspends processing of control signals generated from the remote control unit 12 left inside the vehicle after the recognition of the identification code of the remote control unit 12 left inside the vehicle. When in the suspended state, control unit 12 cannot be used for vehicle operation.

When a driver unlocks the vehicle using another remote control unit held by the driver, an unlocking signal is input to the CPU 21. Thereafter, the CPU 21 releases the suspended state of processing the control signal generated by the remote control unit 12 so as to reinstate the function of the remote control unit 12.

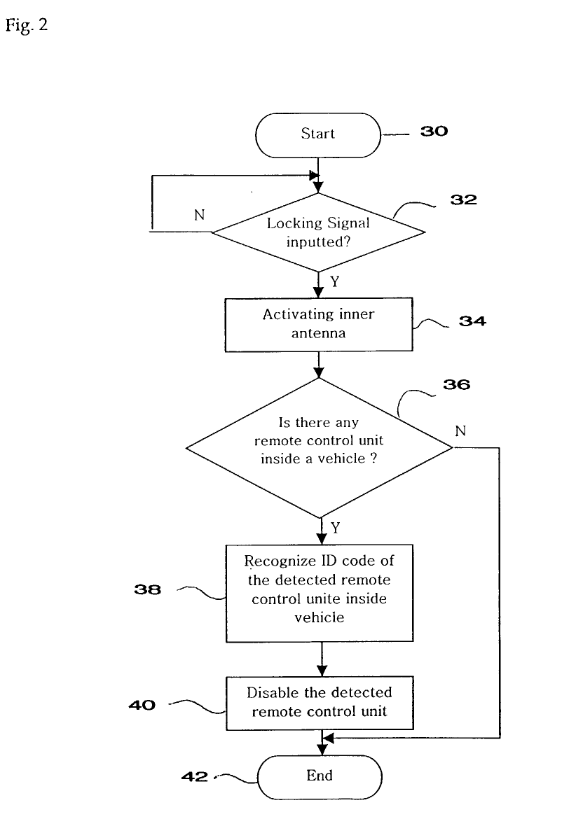

The operation of an apparatus for disabling a remote control unit left in the vehicle according to the present invention is further described with reference to FIG. 2. The method starts at 30 with the vehicle unlocked. The CPU continuously queries for a locking signal input 32 from a remote control unit, e.g., unit 12. Upon receipt of a locking signal inner antenna 24 is activated at 34. Inner antenna 24, as controlled by antenna controller 25 and CPU 21, determines at 36 whether any remote control unit has been left in the vehicle. In the event a remote control is left in the vehicle, the ID code is transferred to the CPU at 38 and if recognized the CPU disables the remote control unit at 40. The process thereafter terminates at 42. Subsequently, when a driver unlocks the vehicle using another remote control unit, e.g. unit 10, the unlocking signal is received by the CPU. In addition to unlocking the vehicle, the CPU also at that time re-enables the previously disabled remote control unit 12 that was left in the vehicle.

What is claimed is:

1. A system for disabling a remote control unit of an automobile, said system comprising:
at least two remote control units for transmitting/receiving a different radio signal unique to each vehicle; and
an ECU for determining the authentication of the remote control units through a bi-directional communication with said remote control units, wherein said ECU includes a CPU controlling locking and unlocking of the vehicle in response to communication with said remote control units, an inner antenna for detecting the presence of the remote control unit left inside a vehicle, and an inner antenna controller for activating said inner antenna and simultaneously inputting a radio signal of the remote control unit detected by said inner antenna to the CPU when a locking signal generated by one of the remote control units is inputted to the CPU.

2. A method for disabling a remote control unit of an automobile comprising:
inputting a locking signal generated from one of a plurality of remote control units carried by a driver into a CPU of a vehicle security system;
detecting the presence of a remote control unit that is accidentally left inside a vehicle;
inputting a radio signal of the remote control unit left inside the vehicle into the CPU;
recognizing, by the CPU, the remote control unit left inside the vehicle through the inputted radio signal; and
temporarily suspending CPU processing of control signals generated by the remote control unit left inside the vehicle.

3. The method of claim 2, further comprising releasing the suspended state of processing the control signal generated by the remote control unit left inside the vehicle when an unlocking signal from another remote control unit carried by a driver is input to the CPU.

4. A vehicle security system, comprising at least two remote control units and a vehicle mounted electronic control unit capable of bi-directional communication with said remote control units, said electronic control unit comprising
a CPU;
a first antenna controller communicating with the CPU;
a first antenna controlled by said first controller for remote bi-directional communication with said remote control units;
a second antenna controller communicating with the CPU; and
a second antenna controlled by the second controller for detecting and receiving signals from a remote control unit located within the vehicle;
wherein said CPU is programmed to disable processing of signals received from a remote control unit that is detected to be within the vehicle by the second antenna.

5. The vehicle security system according to claim 4, wherein said CPU programmed to initiate detection of a remote control unit within the vehicle via the second antenna upon receiving a locking signal via the first antenna and to re-enable processing of signals received from the remote control unit within the vehicle upon receipt of an unlocking signal from another remote control unit via the first antenna.
